(19) United States
(12) Patent Application Publication
(10) Pub. No.: US 2008/0011381 A1
(43) Pub. Date: Jan. 17, 2008

(54) Protective and Thermal Insulative Barrier

(76) Inventor: Stephen B. Squires, Colleyville, TX (US)

Correspondence Address: HECKER & HARRIMAN, SUITE 2300, 1925 CENTURY PARK EAST, LOS ANGELES, CA, 90067, US

(21) Appl. No.: 11/670,388

(22) Filed: Feb. 1, 2007

Related U.S. Application Data
(60) Provisional application No. 60/765,387, filed on Feb. 3, 2006.

(51) Int. Cl. F16L 9/14

(52) U.S. Cl. 138/149; 138/153; 138/172

(57) ABSTRACT

The present invention comprises a multi-component protective and thermally insulative barrier structure that may be retrofitted to pipelines and other physical structures. In one or more embodiments, the invention comprises a multi-component protective blanket or “wrap” that is used to encase a pipeline. In one or more embodiments, the “wrap” comprises three components: a reinforced polymer outer layer for intercepting ballistic ordnance and causing it to detonate, a layer of thermally insulating, blast mitigating material for both stabilizing the temperature with the pipeline during normal operation and for dispersing into and disrupting the blast flame front when detonation and breach of the outer layer occurs, and a reinforced multi-layer inner layer that is intended to prevent ordnance fragments from penetrating to the pipeline itself. In one or more embodiments, the outer layer is attached to circular stand-off ribs that are attached at intervals along the pipeline.

### CROSS REFERENCE TO RELATED PATENT APPLICATION

This patent application claims the benefit of the filing date of U.S. Provisional Patent Application Ser. No. 60/765,387 filed Feb. 3, 2006 entitled “Protective and Thermal Insulative Barrier” the specification and drawings of which are incorporated by reference herein.

### FIELD OF THE INVENTION

This invention relates to the field of protective barriers for physical installations, and more particularly to system and apparatus for providing a combination of thermal insulation and protection from damage from projectiles and similar explosive devices to pipelines and similar installations.

A portion of the disclosure of this patent document contains material, which is subject to copyright protection. The copyright owner has no objection to the facsimile reproduction by anyone of the patent document or the patent disclosure, as it appears in the Patent and Trademark Office file or records, but otherwise reserves all copyrights associated with this document.

### BACKGROUND

Installations such as pipelines that extend for great distances over remote areas are vulnerable to attack and damage from terrorists and others seeking to cause damage and disruption for political, criminal, and other reasons. Because of the physical nature of pipelines, a break in a pipeline at a single location disrupts the flow through the entire pipeline. Accordingly, there is a need for an effective method to physically protect pipelines from damage caused by projectiles and other explosives.

Pipelines are also exposed to varying environmental temperatures over time and over their length that cause the temperature of the substance being transported by the pipeline to fluctuate. Such temperature fluctuations create internal flow resistances that increase the amount of pumping energy needed to convey the substance through the pipeline. Accordingly, a need exists for an effective method to reduce temperature fluctuations within a pipeline.

### SUMMARY OF THE INVENTION

The present invention comprises a multi-component protective and thermally insulative barrier structure that may be retrofitted to pipelines and other physical structures. In one or more embodiments, the invention comprises a multi-component protective blanket or “wrap” that is used to encase a pipeline. In one or more embodiments, the “wrap” comprises three components: a reinforced polymer outer layer for intercepting ballistic ordnance and causing it to detonate, a layer of thermally insulating, blast mitigating material for both stabilizing the temperature with the pipeline during normal operation and for dispersing into and disrupting the blast flame front when detonation and breach of the outer layer occurs, and a reinforced multi-layer inner layer that is intended to prevent ordnance fragments from penetrating to the pipeline itself. In one or more embodiments, the outer layer is attached to circular stand-off ribs that are attached at intervals along the pipeline. The stand-off ribs provide a separation distance between the outside surface of the protective “wrap” of the invention and the pipeline surface itself that provides space to hold the thermal insulative/blast mitigation material and that dissipates remaining blast wave energies to a level that can be generally be withstood by the pipeline structure. The protective wrap of the invention thus provides a unique combination of thermal insulation and physical protection that reduces pipeline flow losses as well protecting against damage from explosive blasts.

### BRIEF DESCRIPTION OF THE DRAWINGS

FIG. 1 shows circular support ribs used in one embodiment of the invention.

FIG. 2 shows the components of a pipeline protection structure of one embodiment of the invention.

FIG. 3 is a cross-sectional diagram showing the components of a pipeline protection structure of one embodiment of the invention.

### DETAILED DESCRIPTION OF THE INVENTION

The present invention comprises a multi-component thermal insulation and blast mitigation structure for use with pipelines and other structures exposed to fluctuating temperatures and possible attacks with ballistic projectiles and other explosive ordnance. The invention will be described with respect to one or more example embodiments. However, the invention is not limited to those embodiments, but encompasses other embodiments comprising the inventive features of the invention, as will be apparent to those of skill in the art.

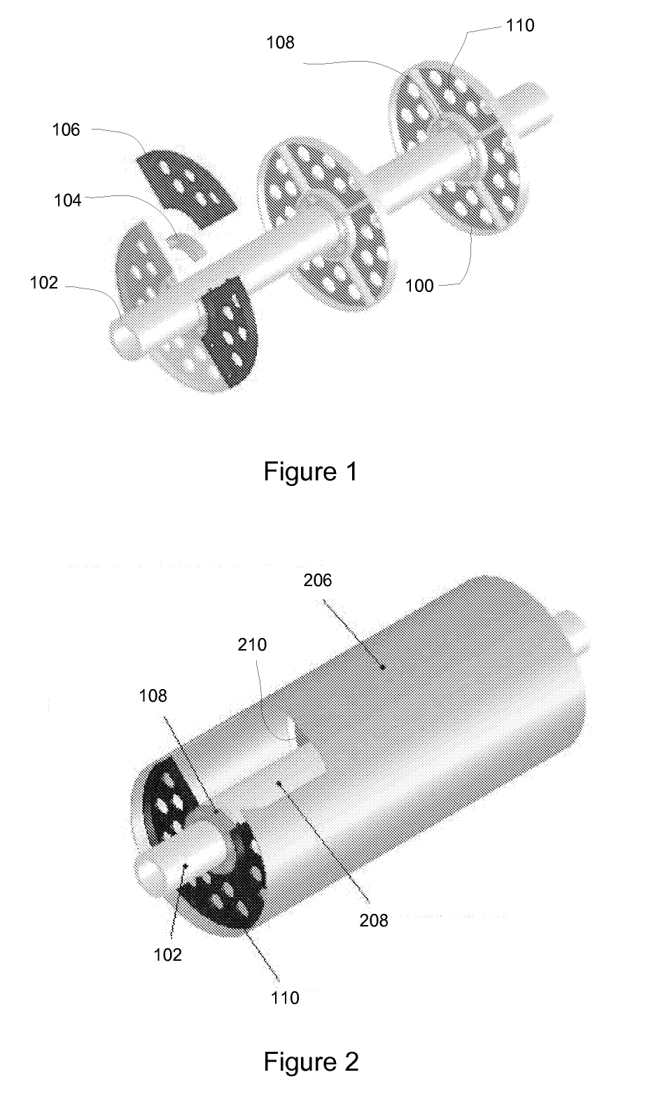

One embodiment of the invention is illustrated in FIGS. 1 to 3. This embodiment comprises an embodiment in which the thermal insulation and blast mitigation structure of the present invention is applied to a pipeline, for example a petroleum transport pipeline. This embodiment comprises generally a series of circular ribs mounted at intervals to the pipeline, an outer sheet wrapped around the ribs, and thermally insulative blast mitigation material and a ballistic fragment barrier disposed between the outer layer and the pipeline surface, as described in greater detail below.

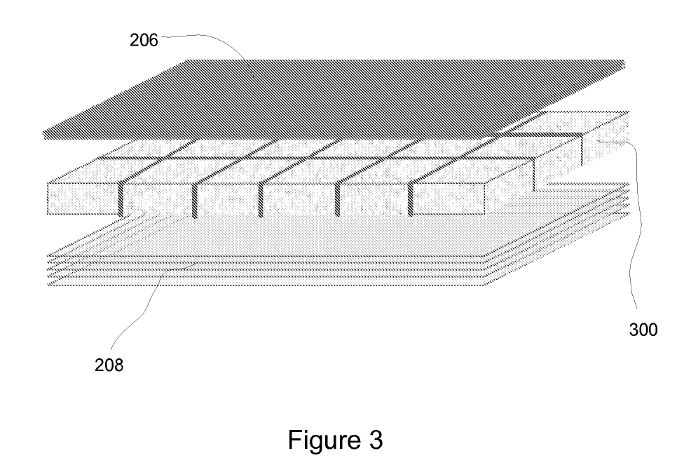

FIG. 1 shows an embodiment of circular stiffening ribs 100 used in an embodiment of the invention. A purpose of the stiffening ribs 100 is to provide a stand-off distance between the surface of pipeline 102 and the outside protective surface of the invention (described in greater detail below with respect to FIGS. 2 and 3), as well as to provide stiffening for the protective structure of the invention.

In the embodiment of FIG. 1, each stiffening rib is constructed of a circular inner support ring 108 and an outer support ring 110. Each of inner support ring 108 and outer support ring 110 are assembled from segments (quadrants 104 and 106, respectively, in the embodiment of FIG. 1) that allow them to be mounted to the outside of an existing pipeline. Inner support ring 108 fits snugly around pipeline 102, and outer support ring 110 is mounted to inner support ring 110. In one or more embodiments, stiffening ribs 100 are mounted at periodic intervals to pipeline 102. In one embodiment, the spacing between adjacent ribs is approximately eight feet. Stiffening ribs 100 may be fabricated from any appropriate material, including metal, plastic, and composites. In one embodiment, ribs 100 are cast from the same organic substance used for the blast mitigation material, described with respect to FIG. 3 below.

FIG. 2 shows the inner and outer layers 208 and 206, respectively, of the protective/insulative barrier of the present invention mounted to pipeline 102 by means of ribs 100.

Outer layer 206 comprises a reinforced sheet of material that is intended to intercept and detonate projectiles directed at pipeline 102. It is wrapped around and attached to the outside of ribs 100. In one or more embodiments, outer layer 206 comprises a reinforced co-polymer material. Examples of appropriate materials include, without limitation, aramid reinforced elastomeric urethanes, aramid reinforced polyurethanes, polyurea elastomers, nanocomposites and advanced nanocomposite reinforced polymers, and fiber reinforced advanced polymers. In one or more embodiments, outer layer 206 comprises a heat-reflective material that has an additional benefit of helping prevent temperature fluctuations within pipeline 102.

Inner layer 208 comprises one or more layers of material whose intended purpose is to intercept ballistic fragments that manage to penetrate the outer layer 206. In one or more embodiments, inner layer 208 comprises multiple layers of a reinforced co-polymer material. Examples of appropriate materials include, without limitation, aramid fiber reinforced elastomeric urethanes, aramid fiber reinforced polyurethanes, polyurea elastomers, nanocomposites and advanced nanocomposite reinforced polymers, and fiber reinforced advanced polymers. In one or more embodiments, inner layer 208 is disposed directly adjacent to the outer surface of pipeline 102. In one or more embodiments, the outer circumference of inner layer 208 is approximately equal to the outer circumference of inner supporting ring 108, leaving an annular space 210 between the outer surface of inner layer 208 and the inner surface of outer layer 206. In one or more embodiments, this annular space 210 is filled with a thermally insulating blast mitigation material, as shown in FIG. 3.

FIG. 3 is a schematic cross sectional view of the multi-component insulative/protective barrier of an embodiment of the invention. FIG. 3 shows the thermally insulating blast mitigation material 300 disposed in the space between outer layer 206 and inner layer 208. The surface being protected (e.g. pipeline 102 in FIG. 2) and the separation/stiffening ribs 100 are not illustrated in FIG. 3. With respect to the embodiment of FIG. 3, the surface or structure being protected (e.g. the outer surface of pipeline 102 in FIG. 2), in use, would be disposed directly underneath inner layer 208.

In one or more embodiments, thermally insulating blast mitigation material 300 comprises a material that is intended both to provide thermal insulation and to mitigate the force of a blast that occurs at or adjacent to outer layer 206. For example, if the outer layer is breached, in one or more embodiment, a portion of the thermally insulating blast mitigation material 300 disperses into the blast flame front, where it has the effect of partially or fully (depending on the blast force) dispersing into the blast flame front, reducing the residual blast energies and slowing any blast fragments sufficiently so that they will not penetrate inner layer 208.

In one or more embodiments, the thermally insulating blast mitigation material 300 comprises an organic substance that is cast into light weight billets that are used to fill the annular space 210 between outer layer 206 and inner layer 208. Examples of materials that are suitable for thermally insulating blast mitigation material 300 include, without limitation, bonded aggregate of hollow or solid powder particles, in particular siliceous rock such as perlite or other volcanic glasses, and syntactic foams, aqueous or solid expanded foams comprised of polymers, metals or ceramics, solid powder aggregates, lightweight materials such as elastomers, aerogels or reinforced aerogels, and any other material that minimizes or reduces shock or blast wave propagation as well as any combination thereof.

The insulating properties of the insulative/protective barrier of the invention reduce the effect of external temperature variations on the internal temperature of the material carried in pipeline 102. Temperature fluctuations in the material transported through pipeline 102 create undesirable resistances that can reduce flow rate and require a greater expenditure of pumping effort to transport material through the pipeline. The insulative property of the insulative/protective barrier of the present invention reduces such temperature fluctuations and thereby reduces the resulting flow resistance, requiring less pumping power to maintain a prescribed flow rate. The combined economic benefits from thermal insulation and blast mitigation provided by the present invention make use of the invention economically feasible in applications where neither thermal insulation or blast mitigation alone would be economically feasible.

Thus, a novel combined thermally insulating and blast mitigating protective barrier has been presented. Although the present invention has been described with respect to particular example embodiments, it will be understood by those of skill in the art that the invention is not limited to those particular embodiments, but includes alternative embodiments that will be evident to those skilled in the art.

1. A multi-component protective and thermally insulative barrier comprising:
a reinforced polymer outer layer;
a layer of thermally insulating, blast mitigating material;
a reinforced multi-layer inner layer.
